(19) United States
(12) Patent Application Publication
(10) Pub. No.: US 2014/0273832 A1
(43) Pub. Date: Sep. 18, 2014

(54) APPARATUS AND METHOD FOR CONNECTING ANTENNA FOR NEARFIELD COMMUNICATION IN PORTABLE TERMINAL

(71) Applicant: Samsung Electronics Co., Ltd., Suwon-si (KR)

(72) Inventor: Seok-Weon KIM, Suwon-si (KR)

(73) Assignee: Samsung Electronics Co., Ltd., Suwon-si (KR)

(21) Appl. No.: 14/200,813

(22) Filed: Mar. 7, 2014

(30) Foreign Application Priority Data
Mar. 13, 2013 (KR) 10-2013-0026691

(51) Int. Cl. H04B 5/00

(52) U.S. Cl. CPC H04B 5/0037
USPC 455/41.1

(57) ABSTRACT

An apparatus and method for connecting an antenna for Near-Field Communication (NFC) in a portable terminal are provided. The method includes determining whether a wireless charging cover including a second antenna for the NFC is mounted in or separated from the portable terminal and connecting an Integrated Circuit (IC) with a first antenna for the NFC or the second antenna according to whether the wireless charging cover is mounted in or separated from the portable terminal, in which the IC provides the NFC and the first antenna is included in a battery.

### PRIORITY

This application claims the benefit under 35 U.S.C. §119(a) of a Korean patent application filed on Mar. 13, 2013 in the Korean Intellectual Property Office and assigned Serial No. 10-2013-0026691, the entire disclosure of which is hereby incorporated by reference.

### BACKGROUND OF THE INVENTION

1. Field of the Invention

The present invention generally relates to a portable terminal. More particularly, the present invention relates to an apparatus and method for connecting an antenna for Near-Field Communication (NFC) in a portable terminal.

2. Description of the Related Art

Portable terminals, such as smart phones, tablets, and any other similar and/or suitable portable electronic devices, provide various useful functions to users through a variety of functions and applications. In this regard, portable terminals have evolved to allow users to use various forms of information by offering the variety of functions. In particular, portable terminals provide a data service to users by using a Near-Field Communication (NFC) function.

Meanwhile, portable terminals provide a wireless charging technique for charging a battery with electric wave energy released from a wireless charging pad. To provide the wireless charging technique to users, a wireless charging cover should be mounted in a portable terminal. However, mounting of the wireless charging cover in the portable terminal may cause degradation of radiation performance of an NFC antenna included in a battery.

FIG. 1 is a block diagram for providing NFC in a portable terminal according to the related art.

Referring to FIG. 1, in order to address the problem of degradation of radiation performance of the NFC antenna, an antenna for NFC is also included in the wireless charging cover. More specifically, a portable terminal includes a NFC Integrated Circuit (IC) 101 for providing NFC, a battery 103 including a first NFC antenna 105 for NFC, a wireless charging cover 107 including a second NFC antenna 109 for NFC, a battery connection portion 111 for connecting the NFC IC 101 with the battery 103, and a wireless charging cover connection portion 113 for connecting the NFC IC 101 with the wireless charging cover 107.

However, if the portable terminal provides NFC to the user via the second NFC antenna 109 of the wireless charging cover 107, then a pattern including the battery connection portion 111 and the first NFC antenna 105 acts as a resistance against the second NFC antenna 109, thus degrading radiation performance of the second NFC antenna 109. Therefore, there is a need for reducing degradation of radiation performance of an NFC antenna.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for connecting an antenna for Near-Field Communication (NFC) in a portable terminal to reduce degradation of radiation performance.

In accordance with an aspect of the present invention, an apparatus for connecting an antenna for NFC in a portable terminal is provided. The apparatus includes an Integrated Circuit (IC) providing the NFC and including an antenna line, a battery including a first antenna for the NFC, a wireless charging cover including a second antenna for the NFC, and an antenna connection portion connecting the IC with the first antenna or the second antenna according to whether the wireless charging cover is mounted in or separated from the portable terminal.

In accordance with another aspect of the present invention, a method for connecting an antenna for NFC in a portable terminal is provided. The method includes determining whether a wireless charging cover including a second antenna for the NFC is mounted in or separated from the portable terminal and connecting an IC with a first antenna for the NFC or the second antenna according to whether the wireless charging cover is mounted in or separated from the portable terminal, in which the IC provides the NFC and the first antenna is included in a battery.

In accordance with another aspect of the present invention, an antenna switching unit of a portable terminal including an IC providing NFC and including an antenna line, a battery including a first antenna for the NFC, and a wireless charging cover including a second antenna for the NFC is provided. The antenna switching unit includes a switch switching a connection of the antenna line of the IC, a power supply terminal receiving a voltage of the battery, and a control terminal receiving a control voltage controlling a position of the switch.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram for providing Near-Field Communication (NFC) in a portable terminal according to the related art;

FIGS. 2A to 2C are block diagrams for providing NFC in a portable terminal according to a first exemplary embodiment of the present invention;

FIGS. 3A to 3C are block diagrams for providing NFC in a portable terminal according to a second exemplary embodiment of the present invention;

FIG. 4 is a flowchart for providing NFC in a portable terminal according to the first exemplary embodiment of the present invention; and

FIG. 5 is a flowchart for providing NFC in a portable terminal according to the second exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A portable terminal, according to exemplary embodiments of the present invention, may be a mobile and/or portable electronic device which is easy to carry, such as a video phone, a cellular phone, a smart phone, an International Mobile Telecommunication (IMT)-2000 terminal, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an Electronic (E)-book, a portable computer, a notebook computer, a tablet computer, a digital camera, or any other similar and or suitable portable electronic device.

FIGS. 2A to 2C are block diagrams for providing Near-Field Communication (NFC) in a portable terminal according to a first exemplary embodiment of the present invention.

Referring to FIGS. 2A to 2C, a portable terminal includes an NFC Integrated Circuit (IC) 201 which provides an NFC function, a battery 203 for supplying power to the portable terminal, and a wireless charging cover 235 which provides a wireless charging function.

Herein, NFC is a communication technique which exchanges various wireless data within a short distance of 10 cm or less. NFC has excellent security, is a low-cost technique, and provides both a data read function and a data write function. The wireless charging function does not require a physical connection of a charging device for the portable terminal with the portable terminal, and instead, charges a battery of the portable terminal by using electric waves radiated from an electric-wave energy transmitter/receiver.

The battery 203 includes a first NFC antenna 205, and the wireless charging cover 235 includes a second NFC antenna 237, a ground 239, and a third resistor R3 241. An antenna switching unit 219 includes a power supply terminal 221, a control terminal 223, a switch 227, an NFC antenna line 225 connected with the NFC IC 201, a first connection terminal S1 connected with a battery connection line 229, and a second connection terminal S2 connected with a third wireless charging cover connection line 231.

In particular, if a voltage input to the control terminal 223 is ‘HIGH’, then the antenna switching unit 219 switches the switch 227 to the first connection terminal S1 to connect the NFC antenna line 225 with the first NFC antenna 205 through the battery connection line 229 and a battery connection portion 207. On the other hand, if the voltage input to the control terminal 223 is ‘LOW’, then the antenna switching unit 219 switches the switch 227 to the second connection terminal S2 to connect the NFC antenna line 225 with the second NFC antenna 237 through the third wireless charging cover connection line 231 and a third wireless charging cover connection portion 213. For example, the voltage input of ‘HIGH’ indicates 3.5V through 5V and the voltage input of ‘LOW’ indicates 0V through 3.5V. However, the present invention is not limited thereto, and a voltage input of ‘HIGH’ and ‘LOW’ may be any suitable voltage level.

More specifically, when the battery 203 is mounted in the portable terminal, a voltage VBAT of the battery 203 is applied to the power supply terminal 221 of the antenna switching unit 219 through a first resistor R1 215. For example, the battery voltage VBAT may be 5V. Since the battery voltage VBAT is applied to the power supply terminal 221, the antenna switching unit 219 is changed from an inactive state to an active state. The battery voltage VBAT is distributed to the first resistor R1 215 and a second resistor R2 217, and a voltage VR2 at the second resistor R2 217 is applied to the control terminal 223 of the antenna switching unit 219. Herein, the second resistor R2 217 is a pull-up resistor of the battery voltage VBAT, and a resistance of the second resistor R2 217 is larger than that of the first resistor R1 215, such that the voltage VR2 at the second resistor R2 217 is ‘HIGH’ and the voltage of ‘HIGH’ is applied to the control terminal 223 of the antenna switching unit 219. For example, the resistance of the first resistor R1 215 may be 100a and the resistance of the second resistor R2 217 may be 1MΩ. However, the present invention is not limited thereto, and the resistance values of the first resistor R1 215 and the second resistor R2 217 may be any suitable resistance value.

Since the voltage of ‘HIGH’ is applied to the control terminal 223 of the antenna switching unit 219, the antenna switching unit 219 switches the switch 227 to the first connection terminal S1 to connect the NFC antenna line 225 with the first NFC antenna 205 through the battery connection line 229 and the battery connection portion 207, as illustrated in FIG. 2B.

If the wireless charging cover 235 is mounted after the battery 203 is mounted, then the third resistor R3 241 of the wireless charging cover 235 is connected with a first wireless charging cover connection portion 209, the ground 239 of the wireless charging cover 235 is connected with a second wireless charging cover connection portion 211, and the second NFC antenna 237 of the wireless charging cover 235 is connected with the third wireless charging cover connection portion 213.

The battery voltage VBAT is then distributed to the first resistor R1 215, the second resistor R2 217, and the third resistor R3 241, and the voltage VR2 at the second resistor R2 217 is applied to the control terminal 223 of the antenna switching unit 219. Herein, the resistance of the third resistor R3 241 is smaller than that of the second resistor R2 217, and the third resistor R3 241 is a pull-down resistance of the battery voltage VBAT and pulls down the voltage VR2 at the second resistor R2 217, such that the voltage VR2 at the second resistor R2 217 is ‘LOW’ and the voltage of ‘LOW’ is applied to the control terminal 223 of the antenna switching unit 219. For example, the resistance of the third resistor R3 241 may be 100KΩ or any other similar and/or suitable resistance value.

Since the voltage of ‘LOW’ is applied to the control terminal 223 of the antenna switching unit 219, the antenna switching unit 219 switches the switch 227 to the second connection terminal S2 to connect the NFC antenna line 225 with the second NFC antenna 237 through the third wireless charging cover connection line 231 and the third wireless charging cover connection portion 231, as illustrated in FIG. 2C.

If the wireless charging cover 235 is separated from the portable terminal, then the battery voltage VBAT is distributed to the first resistor R1 215 and the second resistor R2 217 and the voltage VR2 at the second resistor R2 217 is applied to the control terminal 223 of the antenna switching unit 219. Since the voltage of ‘HIGH’ is applied to the control terminal 223 of the antenna switching unit 219, the antenna switching unit 219 switches the switch 227 to the first connection terminal S1 to connect the NFC antenna line 225 with the first NFC antenna 205 through the battery connection line 229 and the battery connection portion 207.

The NFC IC 201, the antenna switching unit 219, the battery connection portion 207, the first through third wireless charging cover connection portions 209, 211, and 213, and the first and second resistors 215 and 217 are included in a printed circuit board 233.

FIGS. 3A to 3C are block diagrams for providing NFC in a portable terminal according to a second exemplary embodiment of the present invention.

Referring to FIGS. 3A to 3C, the portable terminal includes an NFC IC 301 for providing an NFC function, a battery 311 for supplying power to the portable terminal, and a wireless charging cover 315 for providing a wireless charging function. The portable terminal includes a Radio Frequency (RF) connector 303 connected with the NFC IC 301 through an NFC antenna line 305 and a connection portion 309 connected with the RF connector 303 through a connection line 307. The battery 311 includes a third NFC antenna 313, and the wireless charging cover 315 includes an RF connector coupling portion 319 and a fourth NFC antenna 317.

In particular, the RF connector 303 connects the NFC antenna line 305 with either the third NFC antenna 313 of the battery 311 or a fourth NFC antenna 317 of the wireless charging cover 315, according to whether the wireless charging cover 315 is mounted or separated. To be more specific, the RF connector 303 includes a groove 321 and a mechanical switch (not shown) as illustrated in FIG. 3B, and the RF connector coupling portion 319 includes a pin 323.

After the battery 311 is mounted is mounted in the portable terminal, the RF connector 303 determines whether the wireless charging cover 315 is mounted in the portable terminal. If the pin 323 of the RF connector coupling portion 319 is inserted into the groove 321, then the RF connector 303 determines that the wireless charging cover 315 is mounted in the portable terminal. If the wireless charging cover 315 is mounted, then the RF connector 303 releases a connection between the NFC antenna line 305 and the third NFC antenna 313 and connects the NFC antenna line 305 with the fourth NFC antenna 317, by switching the mechanical switch of the RF connector 303 from the connection portion 307 to the RF connector coupling portion 319, as shown in FIG. 3C.

The RF connector 303 determines whether the wireless charging cover 315 is separated from the portable terminal. If the pin 323 of the RF connector coupling portion 319 leaves the groove 321, then the RF connector 303 determines that the wireless charging cover 315 is separated from the portable terminal. If the wireless charging cover 315 is separated from the portable terminal, then the RF connector 303 releases the connection between the NFC antenna line 305 and the fourth NFC antenna 317 and connects the NFC antenna line 305 with the third NFC antenna 313, by switching the mechanical switch of the RF connector 303 from the RF connector coupling portion 319 to the connection portion 307, as shown in FIG. 3A.

FIG. 4 is a flowchart for providing NFC in a portable terminal according to the first exemplary embodiment of the present invention.

Referring to FIG. 4, in step 401, the antenna switching unit 219 determines whether the wireless charging cover 235 is mounted in the portable terminal. If the wireless charging cover 235 is mounted in the portable terminal, then the antenna switching unit 219 proceeds to step 403, otherwise, if the wireless charging cover 235 is not mounted in the portable terminal, the antenna switching unit 219 repeats step 401. If the voltage of ‘LOW’ is applied to the control terminal 223 of the antenna switching unit 219, then the antenna switching unit 219 determines that the wireless charging cover 235 is mounted.

More specifically, if the wireless charging cover 235 is mounted, the third resistor R3 241 of the wireless charging cover 235 is connected with the first wireless charging cover connection portion 209, the ground 239 of the wireless charging cover 235 is connected with the second wireless charging cover connection portion 211, and the second NFC antenna 237 of the wireless charging cover 235 is connected with the third wireless charging cover connection portion 213.

The battery voltage VBAT is distributed to the first resistor R1 215, the second resistor R2 217, and the third resistor R3 241, and the voltage VR2 at the second resistor R2 217 is applied to the control terminal 223 of the antenna switching unit 219. Herein, the resistance of the third resistor R3 241 is smaller than that of the second resistor R2 217 or that of the first resistor R1 215, and the third resistor R3 241 is a pull-down resistance of the battery voltage VBAT and pulls down the voltage VR2 at the second resistor R2 217, such that the voltage VR2 at the second resistor R2 217 is ‘LOW’ and the voltage of ‘LOW’ is applied to the control terminal 223 of the antenna switching unit 219.

In step 403, the antenna switching unit 219 connects the NFC antenna line 225 with the second NFC antenna 237 through the wireless charging cover connection line 231 and the third wireless charging cover connection portion 213 by switching the switch 227 to the second connection terminal S2, and then step 405 is executed. In step 405, the antenna switching unit 219 determines whether the wireless charging cover 235 is separated from the portable terminal. If the wireless charging cover 235 is separated, then the antenna switching unit 219 goes to step 407, and otherwise, if the wireless charging cover 235 is not separated, then the antenna switching unit 219 repeats step 405.

If the voltage of ‘HIGH’ is applied to the control terminal 223 of the antenna switching unit 219, then the antenna switching unit 219 determines that the wireless charging cover 235 is separated from the portable terminal. To be more specific, if the wireless charging cover 235 is separated from the portable terminal, then the third resistor R3 241 of the wireless charging cover 235 is disconnected from the first wireless charging cover connection portion 209, the ground 239 of the wireless charging cover 235 is disconnected from the second wireless charging cover connection portion 211, and the second NFC antenna 237 of the wireless charging cover 235 is disconnected from the third wireless charging cover connection portion 213.

The battery voltage VBAT is distributed to the first resistor R1 215 and the second resistor R2 217, and the voltage VR2 at the second resistor R2 217 is applied to the control terminal 223 of the antenna switching unit 219. Herein, the second resistor R2 217 is a pull-up resistance of the battery voltage VBAT and the resistance of the second resistor R2 217 is larger than that of the first resistor R1 215, such that the voltage VR2 at the second resistor R2 217 is ‘HIGH’ and the voltage of ‘HIGH’ is applied to the control terminal 223 of the antenna switching unit 219.

In step 407, the antenna switching unit 219 connects the NFC antenna line 225 with the first NFC antenna 205 through the battery connection line 229 and the battery connection portion 207 by switching the switch 227 from the second connection terminal S2 to the first connection terminal S1.

FIG. 5 is a flowchart for providing NFC in a portable terminal according to the second exemplary embodiment of the present invention.

Referring to FIG. 5, in step 501, the RF connector 303 determines whether the wireless charging cover 315 is mounted in the portable terminal. If the pin 323 of the RF connector coupling portion 319 is inserted into the groove 321, then the RF connector 303 determines that the wireless charging cover 315 is mounted in the portable terminal. If the wireless charging cover 315 is mounted, then the RF connector 303 proceeds to step 503, otherwise, if the wireless charging cover 315 is not mounted, then the RF connector 303 repeats step 501.

In step 503, the RF connector 303 releases a connection between the NFC antenna line 305 and the third NFC antenna 313 and connects the NFC antenna line 305 with the fourth NFC antenna 317, by switching the mechanical switch of the RF connector 303 from the connection portion 307 to the RF connector coupling portion 319, as illustrated in FIG. 3C, and proceeds to step 505. In step 505, the RF connector 303 determines whether the wireless charging cover 315 is separated from the portable terminal. If the pin 323 of the RF connector coupling portion 319 leaves the groove 321, then the RF connector 303 determines that the wireless charging cover 315 is separated from the portable terminal. If the wireless charging cover 315 is separated, then the RF connector 303 proceeds to step 507, otherwise, if the wireless charging cover 315 is not separated, then the RF connector 303 repeats step 505.

In step 507, the RF connector 303 releases the connection between the NFC antenna line 305 and the fourth NFC antenna 317 and connects the NFC antenna line 305 with the third NFC antenna 313, by switching the mechanical switch of the RF connector 303 from the RF connector coupling portion 319 to the connection portion 307, as illustrated in FIG. 3A.

In this way, the exemplary embodiments of the present invention provide an apparatus and method for connecting an antenna for NFC in a portable terminal, thereby reducing degradation of radiation performance due to the antenna of the battery in NFC. The exemplary embodiments of the present invention provide such an effect regardless of an on/off status of the power of the portable terminal.

The method for connecting an antenna for NFC in the portable terminal according to the exemplary embodiments of the present invention may be embodied as code that is readable by a computer on a non-transitory computer-readable recording medium. The non-transitory computer-readable recording medium may be any or a combination of a variety of recording devices storing data that is readable by a computer system. Examples of the non-transitory computer-readable recording medium may be a Read-Only Memory (ROM), a Random Access Memory (RAM), a Compact Disc (CD)-ROMs, magnetic tapes, floppy disks, optical data storage devices, and carrier waves such as transmission over the Internet. The non-transitory computer readable recording medium may also be distributed over network coupled computer systems so that the computer readable code is stored and executed in a distributed fashion.

While the invention has been shown and described herein with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for connecting an antenna for Near-Field Communication (NFC) in a portable terminal, the apparatus comprising:
an Integrated Circuit (IC) providing the NFC and including an antenna line;
a battery including a first antenna for the NFC;
a wireless charging cover including a second antenna for the NFC; and
an antenna connection portion connecting the IC with the first antenna or the second antenna according to whether the wireless charging cover is mounted in or separated from the portable terminal.

2. The apparatus of claim 1, wherein the antenna connection portion connects the IC with the second antenna if the wireless charging cover is mounted in the portable terminal, and
wherein the antenna connection portion connects the IC with the first antenna if the wireless charging cover is separated from the portable terminal.

3. The apparatus of claim 1, wherein the antenna connection portion is an antenna switching unit which comprises a switch and a control terminal.

4. The apparatus of claim 3, wherein the antenna switching unit switches the switch to connect the antenna line of the IC with the second antenna if a predetermined first reference voltage is applied to the control terminal.

5. The apparatus of claim 3, wherein the antenna switching unit switches the switch to connect the antenna line of the IC with the first antenna if a predetermined second reference voltage is applied to the control terminal.

6. The apparatus of claim 1, wherein the antenna connection portion is a Radio Frequency (RF) connector which comprises a mechanical switch.

7. The apparatus of claim 6, wherein the RF connector switches the mechanical switch to connect the antenna line of the IC with the second antenna if it is determined that the wireless charging cover is mounted in the portable terminal.

8. The apparatus of claim 6, wherein the RF connector switches the mechanical switch to connect the antenna line of the IC with the first antenna if it is determined that the wireless charging cover is separated from the portable terminal.

9. A method for connecting an antenna for Near-Field Communication (NFC) in a portable terminal, the method comprising:
determining whether a wireless charging cover including a second antenna for the NFC is mounted in or separated from the portable terminal; and
connecting an Integrated Circuit (IC) with a first antenna for the NFC or the second antenna according to whether the wireless charging cover is mounted in or separated from the portable terminal,
wherein the IC provides the NFC and the first antenna is included in a battery.

10. The method of claim 9, wherein the connecting of the IC with the first antenna or the second antenna comprises:
connecting the IC with the second antenna if the wireless charging cover is mounted in the portable terminal; and
connecting the IC with the first antenna if the wireless charging cover is separated from the portable terminal.

11. The method of claim 9, wherein the connecting of the IC with the first antenna or the second antenna comprises switching a switch of the antenna switching unit to connect an antenna line of the IC with the second antenna if a predetermined first reference voltage is applied to a control terminal of the antenna switching unit.

12. The method of claim 9, wherein the connecting of the IC with the first antenna or the second antenna comprises switching a switch of the antenna switching unit to connect an antenna line of the IC with the first antenna if a predetermined second reference voltage is applied to a control terminal of the antenna switching unit.

13. The method of claim 9, wherein the connecting of the IC with the first antenna or the second antenna comprises switching a mechanical switch to connect an antenna line of the IC with the second antenna if mounting of the wireless charging cover is sensed.

14. The method of claim 9, wherein the connecting of the IC with the first antenna or the second antenna comprises switching a mechanical switch to connect an antenna line of the IC with the first antenna if mounting of the wireless charging cover is sensed.

15. An antenna switching unit of a portable terminal including an Integrated Circuit (IC) providing Near-Field Communication (NFC) and including an antenna line, a battery including a first antenna for the NFC, and a wireless charging cover including a second antenna for the NFC, the antenna switching unit comprising:
a switch switching a connection of the antenna line of the IC;
a power supply terminal receiving a voltage of the battery; and
a control terminal receiving a control voltage controlling a position of the switch.

16. The antenna switching unit of claim 15, wherein the switch switches the connection of the antenna line of the IC to connect to the second antenna if a predetermined first reference voltage is applied to the control terminal.

17. The antenna switching unit of claim 15, wherein the switch switches the connection of the antenna line of the IC to connect to the first antenna if a predetermined second reference voltage is applied to the control terminal.

18. The antenna switching unit of claim 15, wherein the antenna switching unit is a Radio Frequency (RF) connector which comprises a mechanical switch.

19. The antenna switching unit of claim 18, wherein the RF connector switches the mechanical switch to connect the antenna line of the IC with the second antenna if it is determined that the wireless charging cover is mounted in the portable terminal.

20. The antenna switching unit of claim 18, wherein the RF connector switches the mechanical switch to connect the antenna line of the IC with the first antenna if it is determined that the wireless charging cover is separated from the portable terminal.
